(19) United States
(12) Patent Application Publication
(10) Pub. No.: US 2011/0091032 A1
(43) Pub. Date: Apr. 21, 2011

(54) METHOD AND APPARATUS FOR INFORMATION REPRODUCTION

(75) Inventors: Jun SATO, Kokubunji-shi (JP); Taku KATO, Kamakura-shi (JP); Shinichi MATSUKAWA, Tokyo (JP); Yuji NAGAI, Sagamihara-shi (JP)

(73) Assignee: KABUSHIKI KAISHA TOSHIBA, Tokyo (JP)

(21) Appl. No.: 12/862,685

(22) Filed: Aug. 24, 2010

(30) Foreign Application Priority Data
Oct. 15, 2009 (JP) 2009-238182

(51) Int. Cl. H04L 9/28

(52) U.S. Cl. 380/28

(57) ABSTRACT

According to one embodiment, a content recording apparatus including, a key preparing section configured to prepare a key to encrypt an acquired stream, a file preparing section configured to add identification information to the acquired stream to prepare a file, a hash calculating section configured to calculate a hash value concerning the identification information added to the stream by the file preparing section, a key file preparing section configured to integrate the hash value calculated by the hash calculating section and the key prepared by the key preparing section to prepare a key file, and a writing section configured to write the key file prepared by the key file preparing section in the protected area of a recording medium.

### CROSS-REFERENCE TO RELATED APPLICATIONS

This application is based upon and claims the benefit of priority from Japanese Patent Application No. 2009-238182 filed Oct. 15, 2009; the entire contents of which are incorporated herein by reference.

### FIELD

Embodiments described herein relates generally to images recording and reproduction apparatuses, i.e., a recording apparatus, a reproduction apparatus and an editing apparatus which can record, reproduce and edit images and music, i.e., contents, and methods of the recording, reproduction and editing.

### BACKGROUND

An image recording/reproduction apparatus (digital recorder) has already broadly spread which digitally records data obtained by compressing images (video) and music (audio), i.e., contents in a hard disk drive (HDD) or an optical disk of DVD standard and reproduces the contents in accordance with a reproduction request. It is to be noted that with the enlargement of a screen of a display apparatus which displays the reproduced image, it is possible to easily obtain an image (video) content corresponding to a high definition television system capable of reproducing the details of the content. Moreover, a music (audio) content having an enhanced sound quality referred to as a high bit rate (HBR) can also easily be obtained.

On the other hand, with the improvement of the recording density of a semiconductor memory typified by, for example, an SD card, there has also been put to practical use an image recording/reproduction apparatus in which the SD card is used as a recording medium instead of the above HDD or optical disk. Therefore, as to the contents recorded in the SD card, the video (image) of the high definition television system and HBR audio (music) are becoming a mainstream.

Meanwhile, the digitally recorded content is only little deteriorated (in image and sound qualities) owing to copying, and hence the content needs to be protected by use of copy protection so that the copying without obtaining any permission of a right holder is limited, whereby several standards have been put to practical use.

Japanese Patent Application Publication (KOKAI) No. 2006-74421 discloses that n hash units are selected from hash units set as fragmented data of a content recorded in a recording medium and that a hash value calculated based on the selected hash units is collated with a collating hash value stored in the recording medium, thereby allowing reproduction in accordance with the collation result.

Japanese Patent Application Publication (KOKAI) No. 2003-99329 discloses that during recording, management information of a recording area is subjected to predetermined calculation (hashing) and recorded and that during reproduction, the value obtained by the predetermined calculation (hashing) of the management information of the recording area is compared with a stored hash value to allow the reproduction in a case where the validity of processing can be judged.

### BRIEF DESCRIPTION OF THE DRAWINGS

A general architecture that implements the various feature of the embodiments will now be described with reference to the drawings. The drawings and the associated descriptions are provided to illustrate embodiments of the invention and not to limit the scope of the invention.

FIG. 1 is an exemplary diagram showing an example of a constitution of a recording apparatus (image recording/reproduction apparatus/editing apparatus) according to an embodiment;

FIG. 2 is an exemplary diagram showing an example of a constitution of a reproduction apparatus (image recording/reproduction apparatus) according to the embodiment;

FIG. 3 is an exemplary diagram showing an example of recording processing (editing processing) by the recording apparatus (image recording/reproduction apparatus/editing apparatus) shown in FIG. 1 or 5 according to the embodiment;

FIG. 4 is an exemplary diagram showing an example of reproduction processing by the reproduction apparatus (image recording/reproduction apparatus) shown in FIG. 2 or 5 according to the embodiment;

FIG. 5 is an exemplary diagram showing an example of another constitution (image recording/reproduction apparatus) of the recording apparatus (editing apparatus) and the reproduction apparatus shown in FIG. 1 or 2 according to the embodiment;

FIGS. 6 to 37 are exemplary diagrams each showing an example of a rule and a data structure applied to recording/editing/reproduction by the image recording/reproduction apparatus (recording apparatus/editing apparatus/reproduction apparatus) shown in FIGS. 1, 2 and 5 according to the embodiment;

FIG. 38 is an exemplary diagram showing an example of the recording processing (editing processing) by the recording apparatus (image recording/reproduction apparatus/editing apparatus) shown in FIGS. 1 and 5 according to the embodiment; and

FIG. 39 is an exemplary diagram showing an example of the reproduction processing by the reproduction apparatus (image recording/reproduction apparatus) shown in FIGS. 2 and 5 according to the embodiment.

### DETAILED DESCRIPTION

Various embodiments will be described hereinafter with reference to the accompanying drawings. In general, according to one embodiment, a content recording apparatus comprising: a key preparing section configured to prepare a key to encrypt an acquired stream; a file preparing section configured to add identification information to the acquired stream to prepare a file; a hash calculating section configured to calculate a hash value concerning the identification information added to the stream by the file preparing section; a key file preparing section configured to integrate the hash value calculated by the hash calculating section and the key prepared by the key preparing section to prepare a key file; and a writing section configured to write the key file prepared by the key file preparing section in the protected area of a recording medium.

Embodiments will now be described hereinafter in detail with reference to the accompanying drawings.

The various modules of the systems described herein can be implemented as software applications, hardware and/or software modules, or components on one or more computers, such as servers. While the various modules are illustrated separately, they may share some or all of the same underlying logic or code.

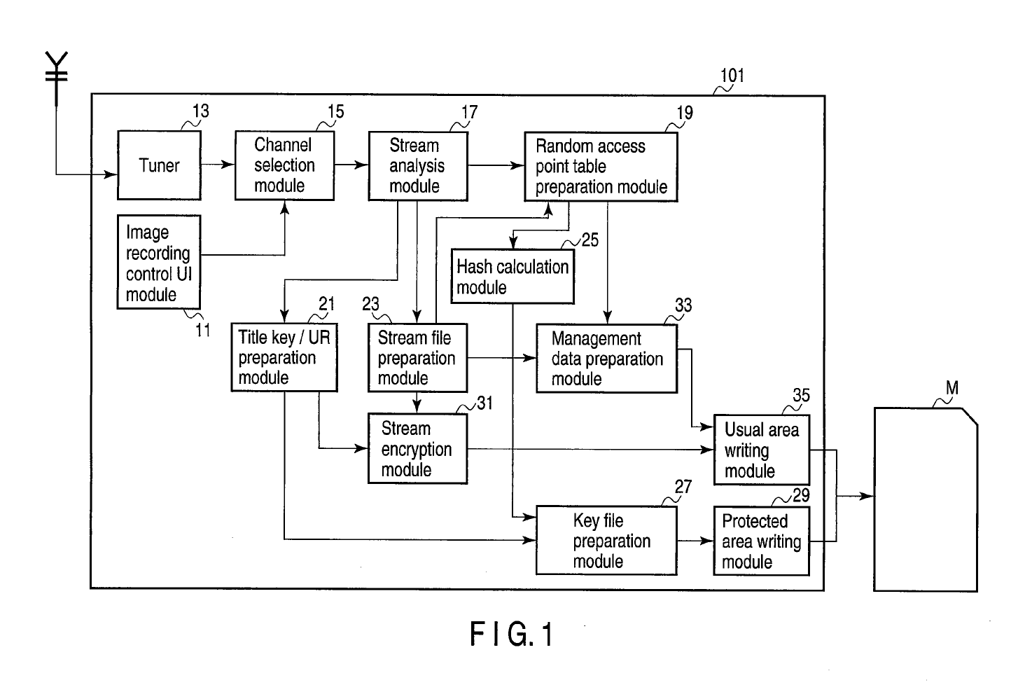

FIG. 1 shows one example of a constitution of a recording apparatus (image recording/reproduction apparatus/editing apparatus) to which one configuration of the embodiment is applied. It is to be noted that the recording apparatus shown in FIG. 1 is a recorder apparatus capable of recording images (video) and music (audio), i.e., contents in a recording medium having a predetermined capacity, for example, a semiconductor memory referred to as an SD card. The apparatus can receive various contents (streams) provided by ground analog broadcasting, ground digital broadcasting, satellite digital broadcasting and a supplier (hereinafter referred to as a conditional access system (CAS)) such as a distribution company (cable television broadcasting company) which distributes programs by a wired system, to record the contents with image and sound qualities desired by a user. Moreover, the contents are referred to as ‘programs’ sometimes. It is to be noted that the image includes a moving picture and a still picture or the display of teletext broadcasting or data broadcasting mainly constituted of texts. Moreover, the recording apparatus (image recording/reproduction apparatus/editing apparatus) may be a set top box (STB) or the like which mainly receives the program distributed from a broadcasting base (distribution) station of the cable television broadcasting company. Furthermore, the recording apparatus (image recording/reproduction apparatus/editing apparatus) may be a television receiving apparatus integrally provided with a display apparatus. It is to be noted that although described later in detail, each element referred to as ‘the module’ may be realized by hardware or may be realized by software by use of a microcomputer or the like typified by a CPU (or an MPU).

In a recording apparatus (image recording apparatus) 101, when image recording processing is designated with respect to the recording apparatus 101 from a user through an image recording control user interface UI (User Interface) module 11, for example, a remote controller or the like, an arbitrary broadcasting wave of the ground digital broadcasting, cable television broadcasting, satellite broadcasting or the like is received by a tuner module 13.

A channel selection processing module 15 selects a channel designated by the user through the image recording control UI module 11 to obtain the data stream of the desired channel. The format of the data stream is, for example, a moving picture experts group (MPEG)-2 transport stream (TS) format.

The data stream (herein the MPEG-2 TS format) is analyzed by a stream analysis module 17, to obtain metadata such as the program name of the data stream or a parameter such as an elementary stream (ES). The stream analysis module 17 also analyzes the elementary stream of the video (image) to obtain the information of an intra-picture (I-picture) of the video elementary stream. It is to be noted that this I-picture information is acquired from the beginning of the video elementary stream to the end thereof.

The information of the I-picture is constituted of the start position of the I-picture, a presentation time stamp (PTS, identification information) thereof and an arrival time stamp (ATS, identification information) thereof. It is to be noted that here, the I-picture is not obtained with reference to another picture, and is a picture which can be decoded alone. In consequence, the position of the I-picture is a reproduction start enabling point.

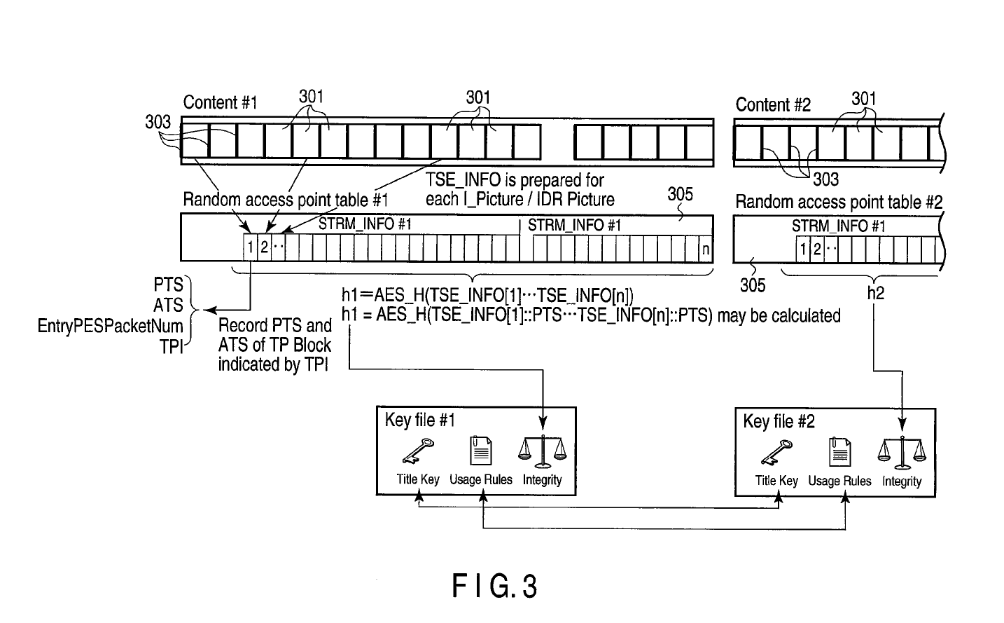

The acquired I-picture information is transmitted to a random access point table preparation module 19, and obtained in the form of a table (information of the I-picture is held as the table) in the random access point table preparation module 19. It is to be noted that the random access point table will be described later in detail with reference to FIG. 3. The table has TSE INFO (n pieces, n is a positive integer) for each I-picture/IDR picture with respect to individual contents. Moreover, the PTS and ATS are specified by a TP block indicated by a TPI.

Furthermore, the stream analysis module 17 analyzes the stream of the MPEG-2 TS format, eventually judges whether or not to encrypt the stream, identifies the use allowing information of the stream and transmits the information to a title key/usage rule (UR, use conditions or a condition file) preparation module 21.

In a case where the stream analysis module 17 judges that the stream should be encrypted, the title key/UR preparation module 21 prepares a title key to encrypt the stream by a random number. The title key/UR preparation module 21 also forms the format of the UR from the use allowing information of the stream received from the stream analysis module 17 as described later in detail.

The stream data analyzed by the stream analysis module 17 is also transmitted to a stream file preparation module 23.

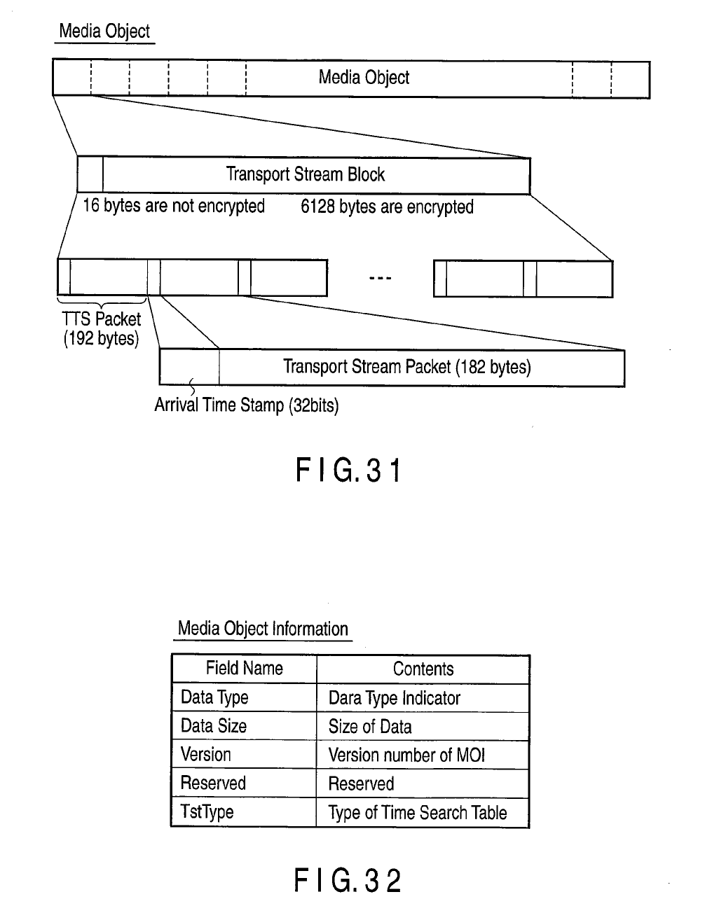

The stream file preparation module 23 converts the stream analyzed by the stream analysis module 17 of the MPEG-2 TS format into a time stamped transport stream (TTS) format. Specific processing will be described in detail with reference to FIG. 31. The ATS of 32 bits is given to the head of the packet (file) of the MPEG-2 TS format stream of 188 bytes to form a TTS packet (file) of 192 bytes.

The random access point table preparation module 19 forms the random access point table concerning the acquired ATS to output the table to a hash calculation module 25.

The hash calculation module 25 obtains the hash value of the above input random access point table by use of a predetermined algorithm (calculation formula). It is to be noted that, for example, SHA1 is used as the algorithm of the hash calculation. Needless to say, another hash algorithm may be used. Moreover, a region where the hash calculation is performed may be the whole random access point table, or a predetermined part of the table may be connected to another part.

A value obtained by the hash calculation of the hash calculation module 25 is input into a key file preparation module 27, and the key file preparation module 27 prepares a key file by use of the title key and UR supplied from the title key/UR preparation module 21. A protected area writing module 29 performs mutual authentication between the prepared key file and an SD card (semiconductor memory (memory card)) M to write the key file in the protected area of the SD card. It is to be noted that the mutual authentication between the key file and the SD card can be realized in a case where the recording apparatus 101 and the SD card M have confidential information (encryption/decryption rule and key information), individually, and authenticate each other by use of the confidential information (encryption/decryption rule and key information) to obtain a temporary session key. That is, the information written in the protected area (information read from the protected area) is encrypted by using the session key, so that the confidential information does not leak out between the recording apparatus 101 and the SD card M. It is to be noted that needless to say, the information to be written in the protected area can be exchanged only when the apparatus and the card can perform the mutual authentication to confirm that they have the same confidential information (encryption/decryption rule and key information) (it is regulated that they cannot exchange the information to be written in the protected area when they do not have the same confidential information).

A stream file encryption module (MPEG encoder) 31 encrypts a stream file prepared by the stream file preparation module 23. To write a stream file prepared by the stream file preparation module 23 in the usual area of a stream main body, and a usual area writing module 35 writes the stream file in the usual area of the SD card M by use of management data prepared by a management data preparation module 33 and corresponding to the random access point table held by the random access point table preparation module 19. It is to be noted that needless to say, the protected area writing module 29 and the usual area writing module 35 may integrally be constituted.

More specifically, the stream file preparation module 23 outputs the stream file of the TTS format.

The stream encryption module 31 encrypts the stream of the TTS format by the file of the TTS format output from the stream file preparation module 23 and the title key prepared by the title key/UR preparation module 21.

The encryption is performed by using, for example, the CBC mode of an advanced encryption standard (AES). Here, the chain of the CBC modes has a prefixed length.

That is, the predetermined number of the TTS packets are encrypted by a series of CBC modes.

The next predetermined number of the TTS packets are encrypted by a new series of CBC modes obtained by resetting the chain of the CBC modes.

The predetermined number of the TTS packets are referred to as a packet sequence (see FIG. 3).

It is to be noted that the head of 16 bytes of the packet sequence is not encrypted, and the remaining part may be encrypted by the CBC mode.

This produces a merit that the time stamp of the packet sequence is not decrypted but can be referred.

Furthermore, a combination of the head of 16 bytes of the non-encrypted part and the title key, for example, a value obtained by a unidirectional function may be used as a packet sequence key.

In consequence, the packet sequence key varies with the packet sequences. This can prevent the tampering of the non-encrypted part.

This encrypted TTS format stream is sent to the usual area writing module 35, and written in a predetermined folder in the usual area of the SD card M.

It is to be noted that in the management data preparation module 33, the program information or image recording time of the recorded stream, metadata such as the file format and the random access point table prepared by the random access point table preparation module are converted into a predetermined format, and written in the predetermined folder of the usual area of the SD card M by the usual area writing module 35 in the same manner as in the stream of the TTS format.

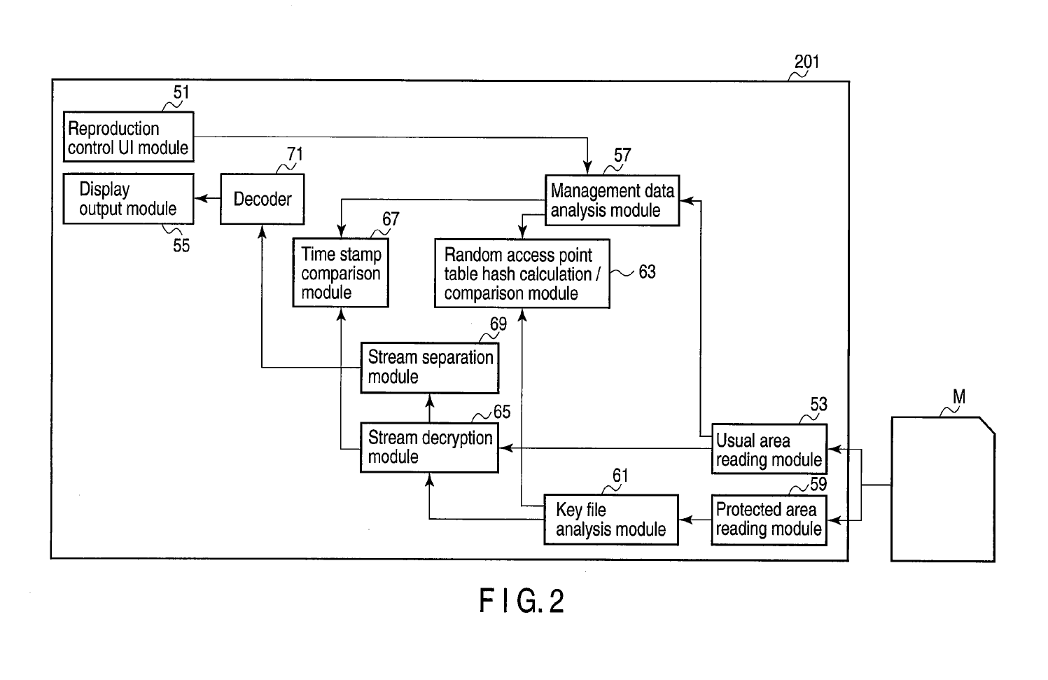

FIG. 2 shows one example of a constitution of a reproduction apparatus (image recording/reproduction apparatus) to which this invention is applied. The constitution will be described.

In a reproduction apparatus 201, when reproduction processing is designated with respect to the reproduction apparatus 201 from a user through a reproduction control UI (User Interface) module 51, for example, a remote controller or the like, the management data held by the SD card (memory card) M is read through a usual area reading module 53 (35), thereby outputting a display output module 55 capable of displaying a list of contents described in the SD card M. It is to be noted that the display output module 55 represents an output end, and is visibly displayed as a list (image) in, for example, a monitor apparatus (not shown) connected to the outside. Moreover, the list is displayed in the display apparatus of a television receiving apparatus or the like to which the monitor apparatus is integrally attached.

When an arbitrary content is selected by the user, the content recorded in the SD card is designated in accordance with a control signal by the reproduction control UI module 51, and the management data is analyzed by a management data analysis module 57. Here (by the analysis of the management data), a necessary content is identified, and the corresponding key file is specified (identified), so that the key file is read from a predetermined folder (key folder) through a protected area reading module 59 (29). It is to be noted that the management data includes the hash value of the random access point table during recording.

That is, after performing the mutual authentication between the reproduction apparatus 201 and the SD card M, the key file is securely read from the protected area reading module 59.

In a case where the read key file can be analyzed by a key file analysis module 61 to confirm that the use conditions (UR) are in a reproducible region, the title key and the hash value are extracted. It is to be noted that prior to the reproduction, a random access point table hash calculation/comparison module 63 compares a value obtained by the hash calculation of the random access point table analyzed by the management data analysis module 57 with the hash value output from the key file analysis module 61.

Next, a reproduction control module (controller) (not shown) judges the result of the above comparison between the hash values. When the comparison becomes successful, that is, when the hash values match each other, reproduction start is allowed. Conversely, when the comparison does not become successful, that is, when the hash values are not matched (mismatched), it is judged that the random access point table is tampered, and the reproduction is not allowed (reproduction is prohibited).

When the reproduction is allowed, a stream decryption module 65 performs decryption processing of the encrypted stream by use of the title key from the key file analysis module 61. At this time, the stream is decrypted while confirming time stamp information which is a plain text at the head of each packet sequence (encrypted information becomes non-encrypted (is decrypted)).

Moreover, the management data analysis module 57 holds the random access point table, and during the reproduction, the table is collated so as to judge that the time stamp (ATS and/or PTS) described in this table is actually present in the TTS stream. It is to be noted that the collating operation is performed by a time stamp comparison module 67. Here, in a case where it is judged that the time stamp present in the random access point table is not present in the TTS stream, the reproduction is stopped (reproduction is discontinued).

It is to be noted that the comparison between the time stamps may be performed with respect to all the table entries of all the random access point tables, or with a predetermined frequency.

The TTS stream decrypted (formed into plain text) by the stream decryption module 65 is separated into audio (voice and/or music), video (image) and another elementary stream (ES) by a stream separation module 69.

Each elementary stream (ES) is decoded by a decoder (MPEG decoder) 71, and output to the display output module 55.

FIG. 3 shows the recording of the data into the memory card (SD card) by the recording apparatus described with reference to FIG. 1 from the viewpoint of the data.

Apparently from FIG. 3, the stream of the TTS format and the random access point table are recorded in the usual area of the SD card M, and a key management file is recorded in the protected area of the SD card M.

Packet sequences (PS) 301 each constituted of the predetermined number of the TTS packets of the stream file of the TTS format are arranged alternately with time stamps 303 which are non-encrypted parts.

Moreover, in a random access point table 305, the time stamp information of the packet sequence including the head of the I-picture of the video, for example, the ATS, the PTS, an entry PES packet num (EPPN) (packet sequence number, i.e., the number indicating the number of the packet sequences to be read to decode an I-frame) and the TPI (address of packet sequence) are stored as STRM_INFO (n pieces, n is a positive integer).

The hash value or an authentication code (MAC) of this random access point table or an authentication code (CMAC) of a common key base, i.e., the digest of the random access point table is stored in the above key file (digest of the random access point table is recorded in the key file). A region where the digest of the random access point table is obtained may be the whole table including all fields constituting the access point table, or a part of the constitution of the access point table, for example, the only ATS or PTS or a compositive combination of them. FIG. 3 shows a case where the hash value is obtained from a hash function based on an AES cipher.

That is, in the present suggestion, ‘the stream file’, ‘the random access point table’ and ‘the key file’ have a “one-to-one” correspondence. Needless to say, the present suggestion is not bound by this correspondence, and relations such as ‘multiple (two or more) stream files’, ‘a pair of random access point tables’ and ‘one key file’ are also established.

It is to be noted that for the sake of the convenience of a file system, when the stream file of the TTS format reaches a predetermined file size (4 G bytes), the data is recorded in another TTS format stream file sometimes. In this case, the key file is separated.

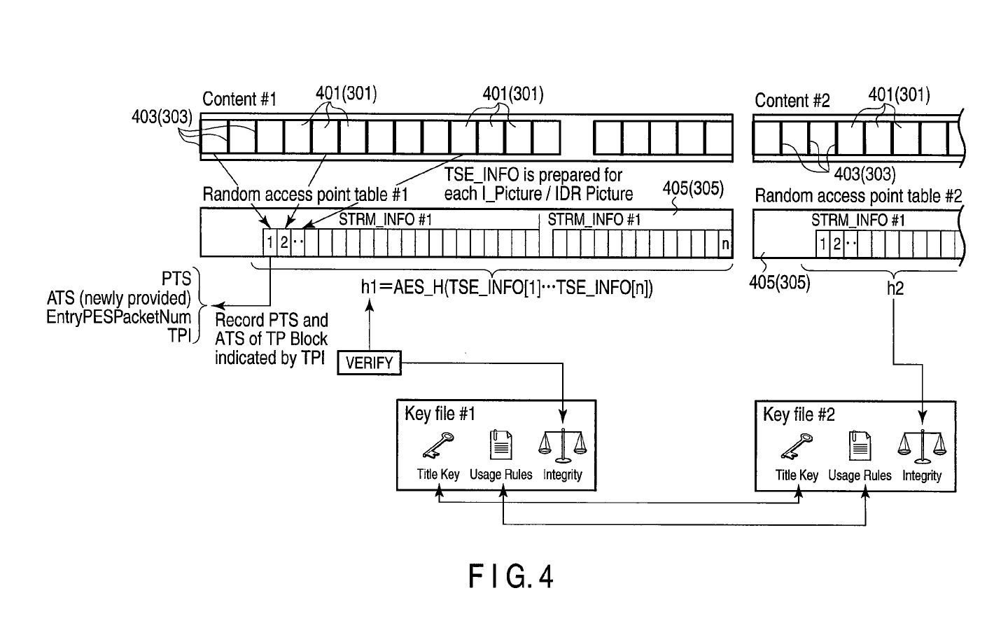

FIG. 4 shows the reproduction of the data from the memory card (SD card) by the reproduction apparatus described with reference to FIG. 2 from the viewpoint of the data.

A data structure is the same as that of FIG. 3, and hence the description thereof is omitted. To reproduce the data, a hash value of a random access point table 405 (305 in FIG. 3) is compared with a hash value recorded in a key file before the reproduction. When the hash values are collated (both hash values match each other), the reproduction is started (reproduction is allowed).

It is to be noted that only in a case where during the reproduction, the time stamp of the random access point table is compared with the actual time stamp (ATS and/or PTS) of the stream of the TTS format and the time stamps match each other, the reproduction is continued (when the values are mismatched, the reproduction is discontinued).

It is to be noted that the confirmation during the reproduction shown in FIG. 4 is performed not only during the reproduction but also during editing, for example, before the execution of each of operations such as content dividing, combining, partial deletion, copying (duplication) and moving. Moreover, during the editing, the content may or may not be re-encrypted by another title key. It is to be noted that the MAC (title key & usage rule (UR)) is recorded in the random access point table so that the title key can closely be concerned with the ATS.

This method solves problems of the present editing function which are demanded to be solved:
1) the title key which encrypts the content as a moving target needs to be securely deleted, and hence all the contents that share this title key cannot be used; and
2) all the contents using the title key which encrypts the content as the moving target need to be moved in a lump (together).

That is, when the content is moved within the same recording medium (media) or to a different recording medium, a content of a portion other than a desired portion does not become unusable but can be left so that the content can continuously be utilized.

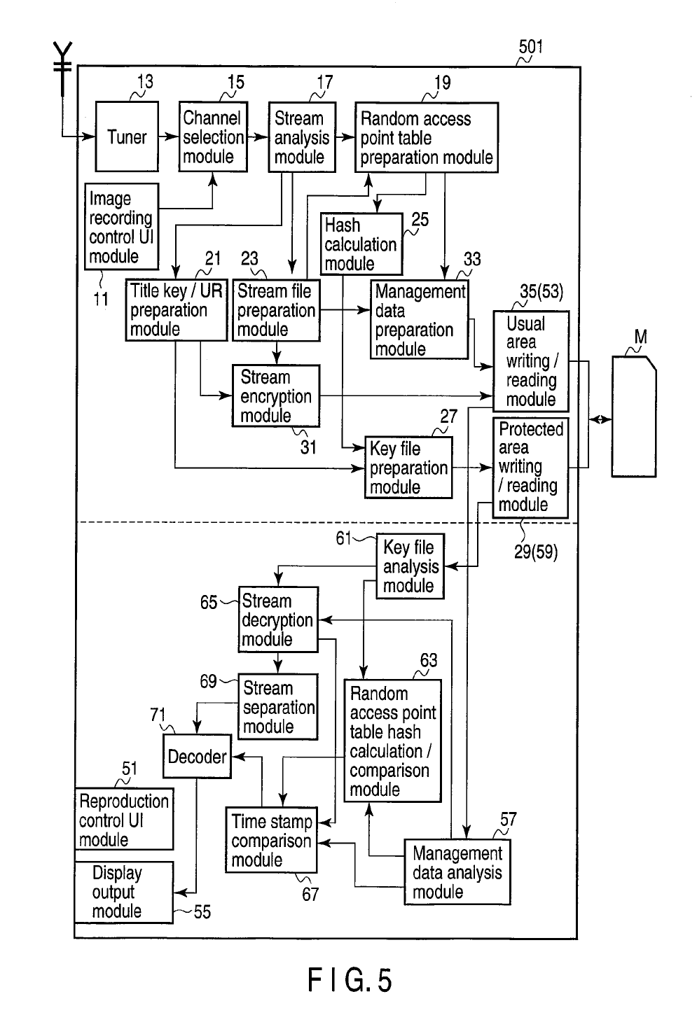

FIG. 5 shows one example of a constitution of an image recording/reproduction apparatus in which the recording apparatus (image recording apparatus/editing apparatus) shown in FIG. 1 and the reproduction apparatus shown in FIG. 2 are integrated. It is to be noted that an image recording apparatus (editing apparatus) for exclusive use in image recording and a reproduction apparatus for exclusive use in reproduction are prepared independently sometimes. However, in many cases, the protected area reading module 59 described with reference to FIG. 2 and the protected area writing module 29 described with reference to FIG. 1 are integrally provided, and needless to say, the usual area reading module 53 described with reference to FIG. 2 and the usual area writing module 35 described with reference to FIG. 1 are integrally provided.

That is, in many cases, an image recording/reproduction apparatus 501 shown in FIG. 5 includes a recording/reproduction module 503 which records (writes) information in the SD card (memory card) M, and reproduces (reads) the information from the SD card M, and elements of the image recording (editing) apparatus shown in FIG. 1 and elements of the reproduction apparatus shown in FIG. 2 are provided around the recording/reproduction module 503.

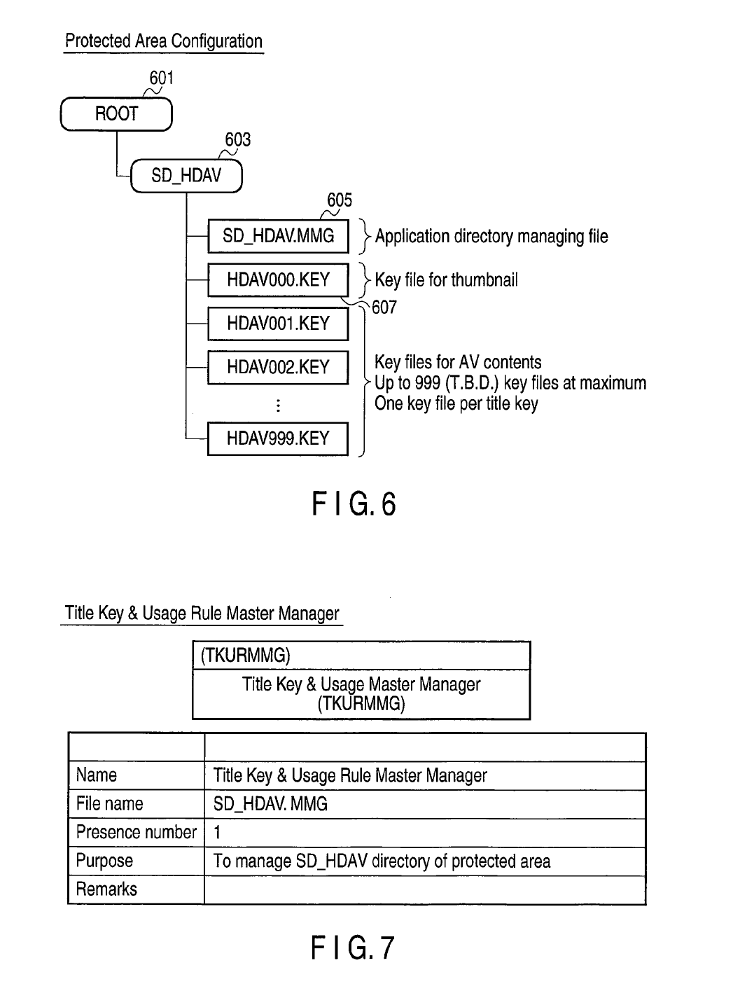

FIG. 6 is a schematic diagram showing one example of a rule (application) applied to the recording apparatus (editing apparatus) shown in FIG. 1, the reproduction apparatus (editing apparatus) shown in FIG. 2 and the image recording/reproduction apparatus (editing apparatus) shown in FIG. 5 and a data structure recommended by the same rule, and showing the structure of a protected area configuration (PAC).

The protected area configuration shown in FIG. 6 indicates that SD_HDAV 603 included in a root 601 includes an application directory managing file (SD_HDAV.MMG) 605, a key file for thumbnail (HDAV000.KEY) 607 and a plurality of key files (HDAV001.KEY . . . ) for audio/video (AV) contents.

It is to be noted that as to the plurality of key files for AV contents, one key file per title key is defined. Moreover, numeric values attached to file names are represented by decimal numbers.

FIG. 7 is similarly a schematic diagram showing one example of the rule (application) applied to the image recording/reproduction apparatus shown in FIGS. 1, 2 and 5 and the data structure recommended by the same rule, and showing a structure of a title key and a usage rule (UR), i.e., a title key & usage rule (UR) master manager (TKURMMG).

The TKURMMG shown in FIG. 7 corresponds to the application directory managing file (SD_HDAV.MMG) 605 shown in FIG. 6, and manages the SD_HDAV directory of the protected area.

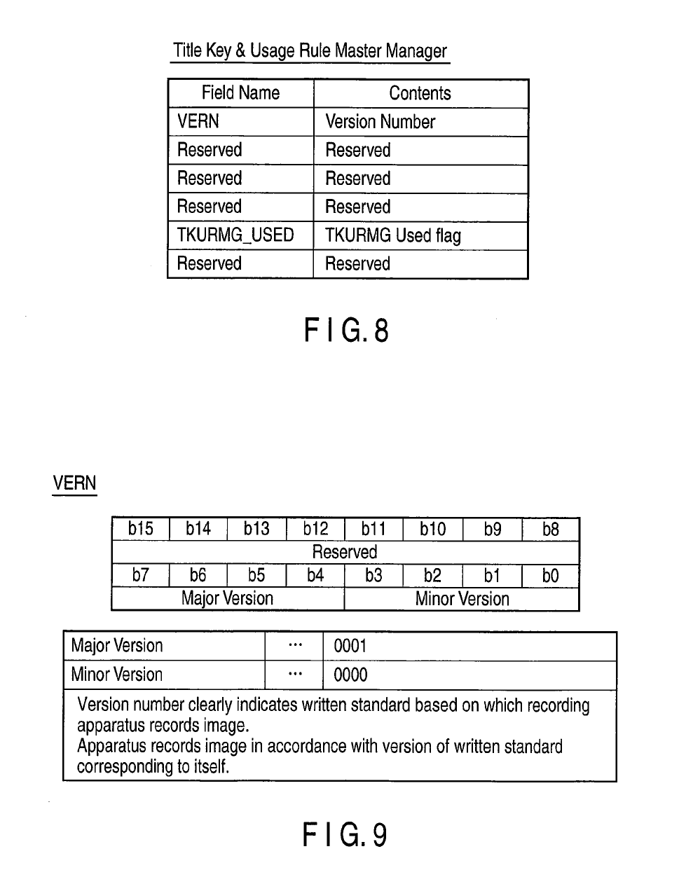

FIG. 8 is similarly a schematic diagram showing one example of the rule (application) applied to the image recording/reproduction apparatus shown in FIGS. 1, 2 and 5 and the data structure recommended by the same rule, showing a title key and UR, i.e., a part of data included in the title key & usage rule master manager (TKURMMG), and including at least a field name VERN in which ‘a version number’ is stored and a field name TKURMG_USED in which ‘a TKURMG used flag’ is stored.

FIG. 9 is similarly a schematic diagram showing one example of the rule (application) applied to the image recording/reproduction apparatus shown in FIGS. 1, 2 and 5 and the data structure recommended by the same rule, and showing one example of a description content of the field name VERN included in the title key & usage rule master manager (TKURMMG) shown in FIG. 7.

As shown in FIG. 9, the field name VERN includes at least ‘a major version’ and ‘a minor version’, and clearly indicates a written standard based on which the recording apparatus (used for image recording) records the image. It is to be noted that the apparatus records the image in accordance with the version of the written standard corresponding to itself.

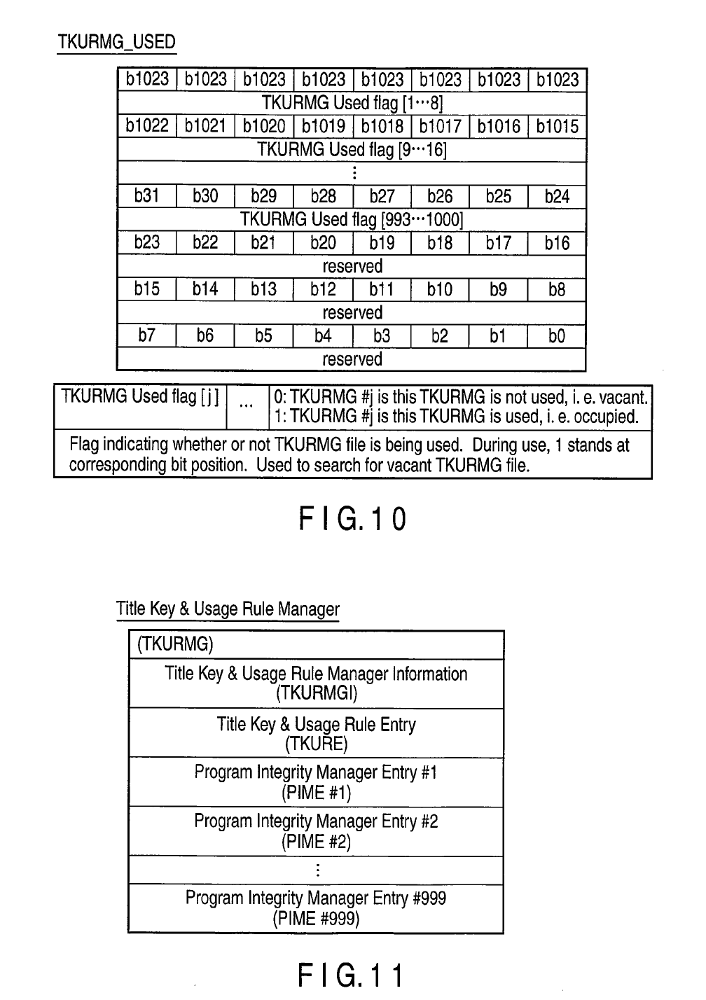

FIG. 10 is similarly a schematic diagram showing one example of the rule (application) applied to the image recording/reproduction apparatus shown in FIGS. 1, 2 and 5 and the data structure recommended by the same rule, and showing one example of a description content of the field name TKURMG_USED included in the title key & usage rule master manager (TKURMMG) shown in FIG. 7.

As shown in FIG. 10, the field name TKURMG_USED includes the arbitrary number of ‘the TKURMG used flags’ indicating whether or not the TKURMG is being used.

When it is being used, ‘1’ stands at the corresponding bit position. Therefore, the flag can be utilized to search for the vacant TKURMG file.

FIG. 11 is similarly a schematic diagram showing one example of the rule (application) applied to the image recording/reproduction apparatus shown in FIGS. 1, 2 and 5 and the data structure recommended by the same rule, and showing the data structure included in the title key & usage rule manager (TKURMG) shown in FIG. 7.

As shown in FIG. 11, the title key & usage rule manager (TKURMG) includes title key & usage rule manager information (TKURMGI), title key & usage rule entry (TKURE) and the arbitrary number of program integrity manager entry #1, . . . , (PIME #1, . . . ,).

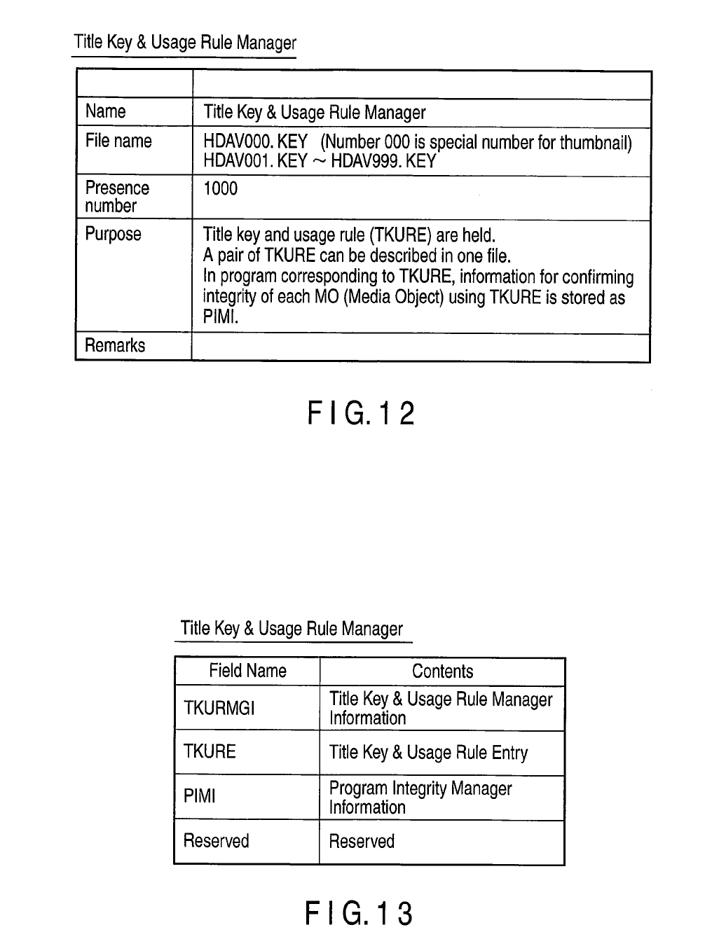

FIG. 12 is similarly a schematic diagram showing one example of the rule (application) applied to the image recording/reproduction apparatus shown in FIGS. 1, 2 and 5 and the data structure recommended by the same rule, and showing the function of the title key & usage rule manager (TKURE) shown in FIG. 11.

That is, TKURE holds the title key and usage rule (TKURE). As to TKURE, a pair of TKURE can be described in one file.

Therefore, in a program corresponding to TKURE, information for confirming the integrity of a media object (MO) using TKURE is stored as program integrity manager information (PIMI).

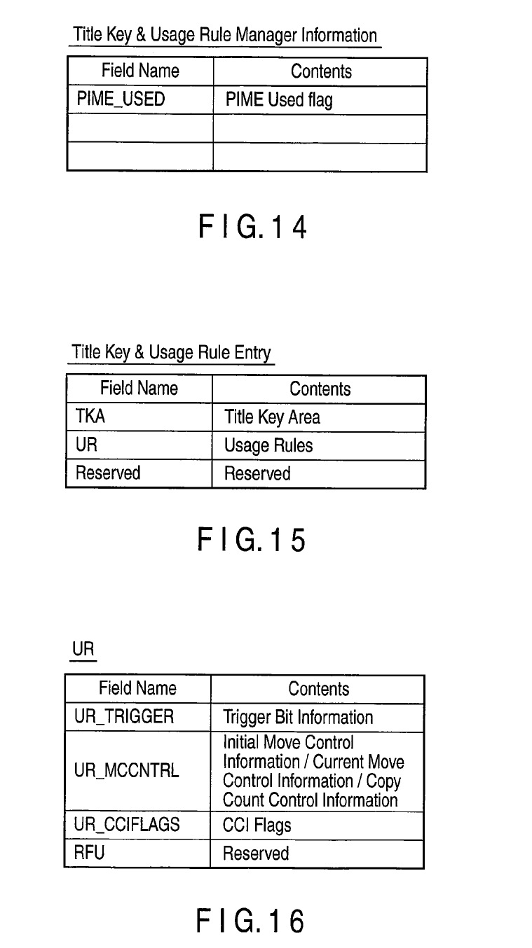

FIGS. 13, 14 and 15 are similarly schematic diagrams each showing one example of the rule (application) applied to the image recording/reproduction apparatus shown in FIGS. 1, 2 and 5 and the data structure recommended by the same rule, and showing description examples of ‘TKURMGI’, ‘TKURE’, ‘PIMI’, ‘PIMI_USED’ and ‘UR’.

FIG. 16 is similarly a schematic diagram showing one example of the rule (application) applied to the image recording/reproduction apparatus shown in FIGS. 1, 2 and 5 and the data structure recommended by the same rule, and showing a structure of ‘UR’ shown in FIG. 15.

That is, ‘UR’ holds UR_TRIGGER (trigger bit information), UR_MCCNRL (initial move control information/current move control information/copy count control information) and UR_CCIFLAGS (CCI flags).

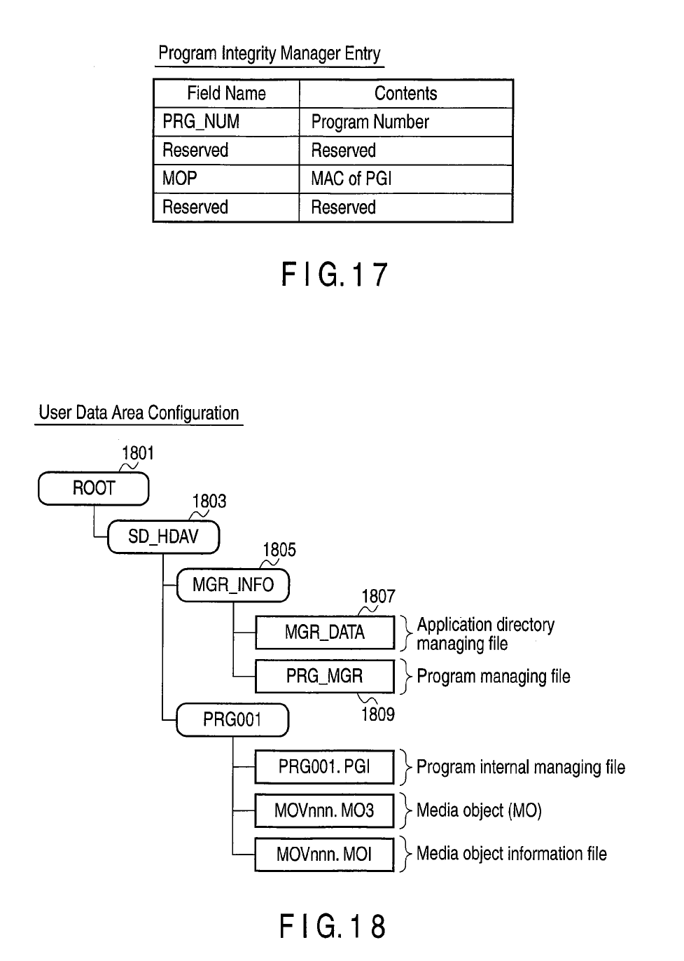

FIG. 17 is similarly a schematic diagram showing one example of the rule (application) applied to the image recording/reproduction apparatus shown in FIGS. 1, 2 and 5 and the data structure recommended by the same rule, and showing a structure of ‘the program integrity manager information (PIME)’ shown in FIG. 15.

That is, ‘the PIME’ holds at least a program number (PRG_NUM) and MAC of PGI (MOP). It is to be noted that MAC corresponds to AES-CMAC, and is obtained by connecting MO_INFO in PGI having this index (TkureIndex) in the program. Moreover, AES-CMAC indicates a cipher-based message authentication code regulated by IEFF RFC4493 standard.

FIG. 18 is a schematic diagram showing one example of the rule (application) applied to the recording apparatus (editing apparatus) shown in FIG. 1, the reproduction apparatus (editing apparatus) shown in FIG. 2 and the image recording/reproduction apparatus (editing apparatus) shown in FIG. 5 and the data structure recommended by the same rule, and showing a structure of a user data area configuration.

In the user data area configuration shown in FIG. 18, SD_HDAV 1803 included in a root 1801 includes MGR_INFO 1805. It is to be noted that when a new program is recorded, a directory which starts with PRG001 is prepared.

Moreover, the MGR_INFO 1805 includes an application directory managing file (MGR_DATA) 1807 and a program managing file (PRG_MGR) 1809.

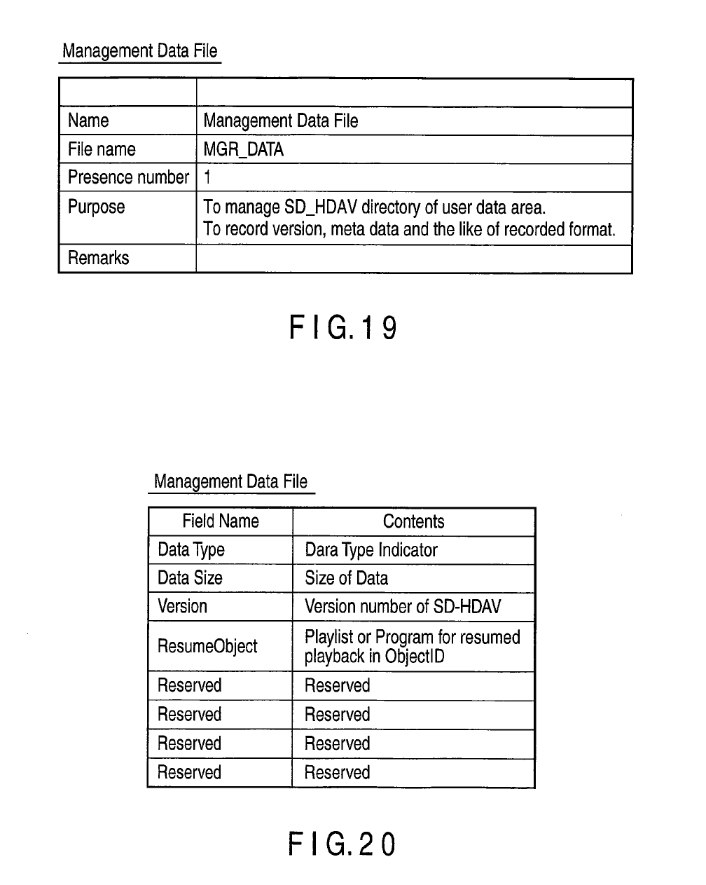

FIG. 19 is similarly a schematic diagram showing one example of the rule (application) applied to the image recording/reproduction apparatus shown in FIGS. 1, 2 and 5 and the data structure recommended by the same rule, and showing the function of the application directory managing file (MGR_DATA) 1807 shown in FIG. 18.

That is, the management data file (MGR_DATA) manages the SD_HDAV of a user data area, and records the version, metadata and the like of the recorded format.

FIG. 20 is similarly a schematic diagram showing one example of the rule (application) applied to the image recording/reproduction apparatus shown in FIGS. 1, 2 and 5 and the data structure recommended by the same rule, showing a part of data included in the management data file (MGR_DATA) shown in FIG. 19, and including at least a field name Data Type in which ‘a data type indicator’ is stored; a field name Data Size in which ‘the size of data’ is stored; a field name Version in which ‘the version number of SD_HDAV’ is stored; and a field name ResumeObject in which ‘a playlist or program for resumed playback in object ID’ is stored.

FIG. 21 is similarly a schematic diagram showing one example of the rule (application) applied to the image recording/reproduction apparatus shown in FIGS. 1, 2 and 5 and the data structure recommended by the same rule, and showing the functions of Data Type, Data Size, Version and ResumeObject shown in FIG. 20.

That is, a file identifier is stored in the data type. Moreover, the size (in unit of byte) of the present file is stored in the data size. Furthermore, the version number of the present format is written in the version. It is to be noted that in the resume object, the lastly reproduced portion, for example, the program or playlist number and the final reproduction timing therein are recorded.

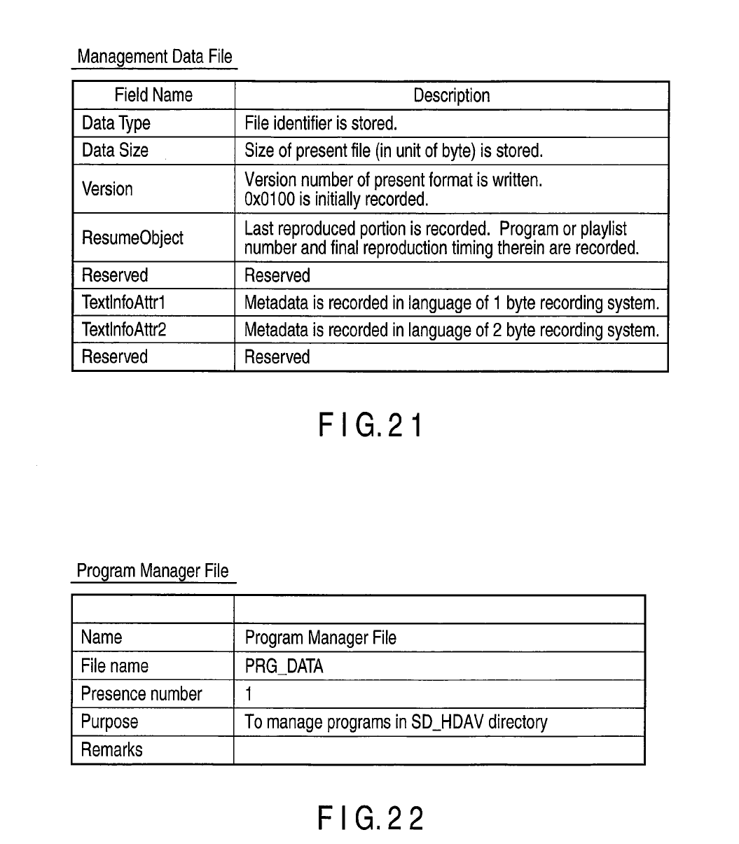

FIG. 22 is similarly a schematic diagram showing one example of the rule (application) applied to the image recording/reproduction apparatus shown in FIGS. 1, 2 and 5 and the data structure recommended by the same rule, and showing the function of the program manager file (PRG_DATA) 1809 shown in FIG. 18.

That is, the program manager file (PRG_DATA) manages the programs in the SD_HDAV directory.

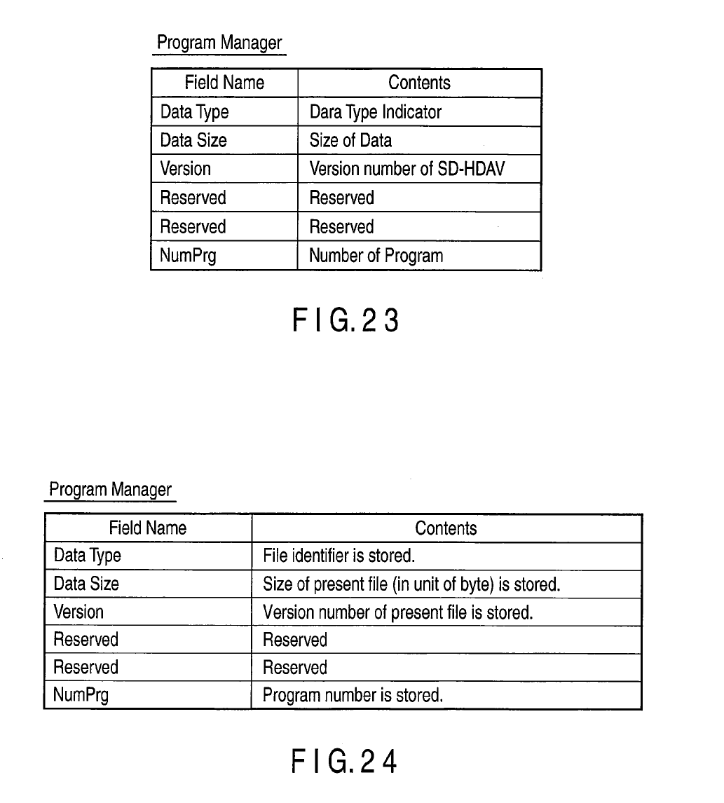

FIG. 23 is similarly a schematic diagram showing one example of the rule (application) applied to the image recording/reproduction apparatus shown in FIGS. 1, 2 and 5 and the data structure recommended by the same rule, showing a part of data included in the program manager file (PRG_DATA) shown in FIG. 22, and including at least a field name Data Type in which ‘a data type indicator’ is stored; a field name Data Size in which ‘the size of data’ is stored; a field name Version in which ‘the version number of SD_HDAV’ is stored; and a field name NumPrg in which ‘the number of programs’ is stored.

FIG. 24 is similarly a schematic diagram showing one example of the rule (application) applied to the image recording/reproduction apparatus shown in FIGS. 1, 2 and 5 and the data structure recommended by the same rule, and showing the functions of the Data Type, Data Size, Version and NumPrg shown in FIG. 23.

That is, a file identifier is stored in the data type. Moreover, the size (in unit of byte) of the present file is stored in the data size. Furthermore, the version number of the present format is written in the version. It is to be noted that in NumPrg, the number of the programs is recorded.

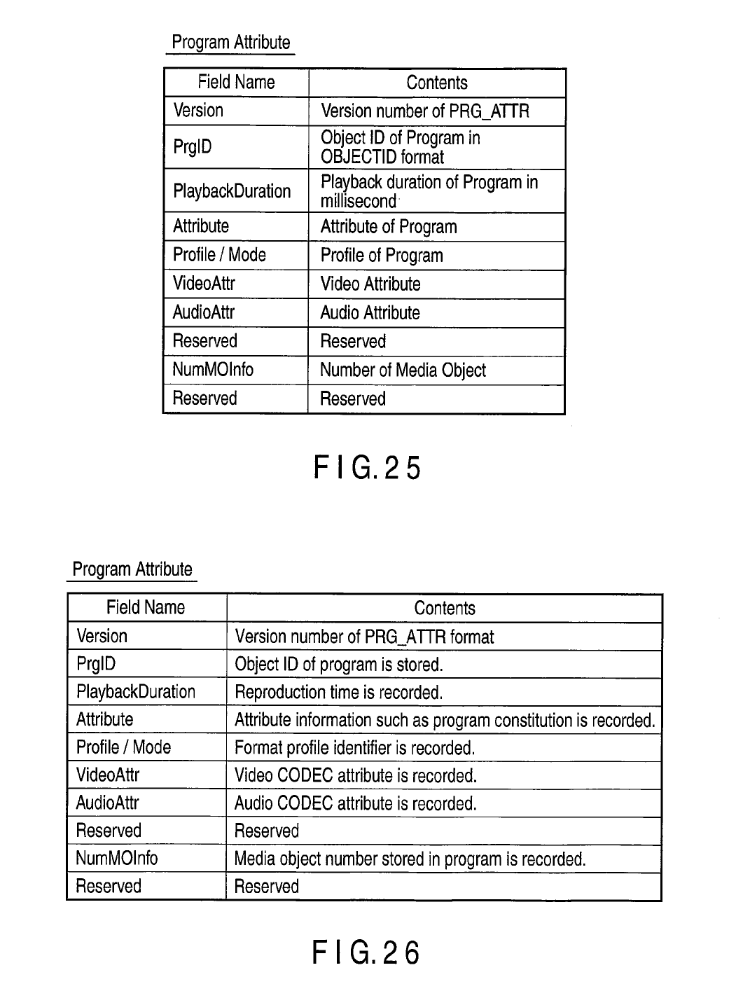

FIG. 25 is similarly a schematic diagram showing one example of the rule (application) applied to the image recording/reproduction apparatus shown in FIGS. 1, 2 and 5 and the data structure recommended by the same rule, showing a part of data included in the program attribute, and including at least a field name Version in which ‘the version number of PRG_ATTR’ is stored and a field name PrgID in which ‘the object ID of the program in OBJECT ID format’ is stored.

FIG. 26 is similarly a schematic diagram showing one example of the rule (application) applied to the image recording/reproduction apparatus shown in FIGS. 1, 2 and 5 and the data structure recommended by the same rule, and showing the functions of VERSION and PrgID shown in FIG. 25.

That is, the version number of PRG_ATTR format is stored in VERSION. Moreover, the object ID of the program is recorded in Prg ID.

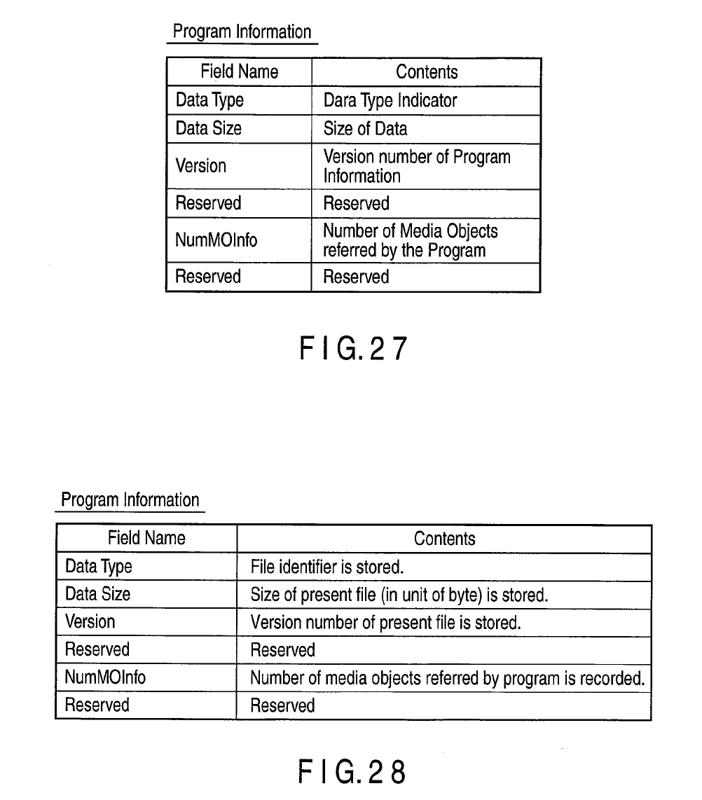

FIG. 27 is similarly a schematic diagram showing one example of the rule (application) applied to the image recording/reproduction apparatus shown in FIGS. 1, 2 and 5 and the data structure recommended by the same rule, showing a part of data included in program information, and including at least a field name Data Size in which ‘a data type indicator’ is stored.

FIG. 28 is similarly a schematic diagram showing one example of the rule (application) applied to the image recording/reproduction apparatus shown in FIGS. 1, 2 and 5 and the data structure recommended by the same rule, and showing the functions of the program information and the data size shown in FIG. 27.

That is, the file identifier is stored in the program information. Moreover, the size (in unit of byte) of the present file is stored in the data size.

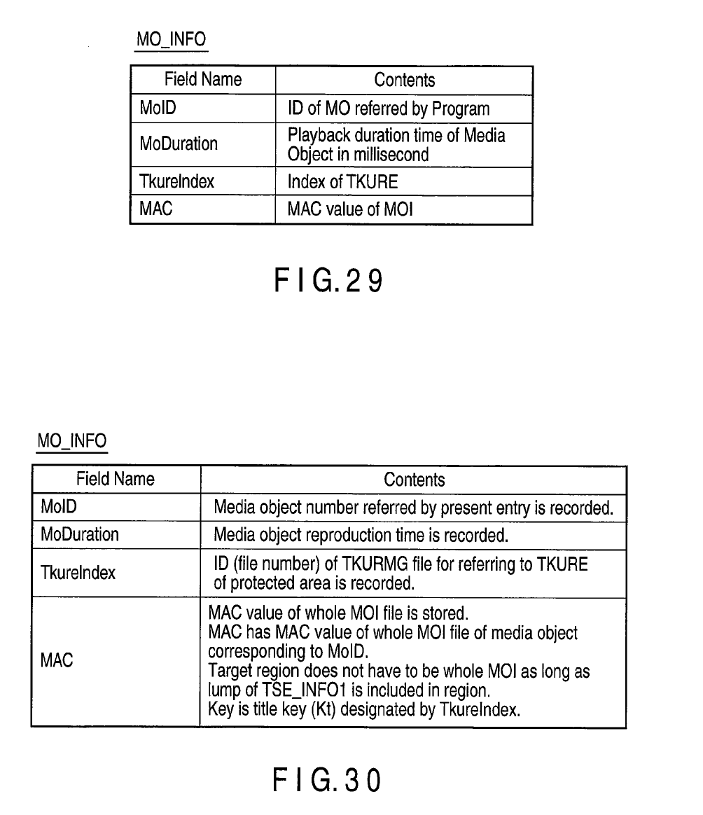

FIG. 29 is similarly a schematic diagram showing one example of the rule (application) applied to the image recording/reproduction apparatus shown in FIGS. 1, 2 and 5 and the data structure recommended by the same rule, showing a part of data included in MO_INFO, and including at least a field name MoID in which ‘the ID of the MO referred by the program’ is stored and a field name MAC in which ‘the MAC value of MOI’ is stored.

FIG. 30 is similarly a schematic diagram showing one example of the rule (application) applied to the image recording/reproduction apparatus shown in FIGS. 1, 2 and 5 and the data structure recommended by the same rule, and showing the functions of MoID and MAC shown in FIG. 29.

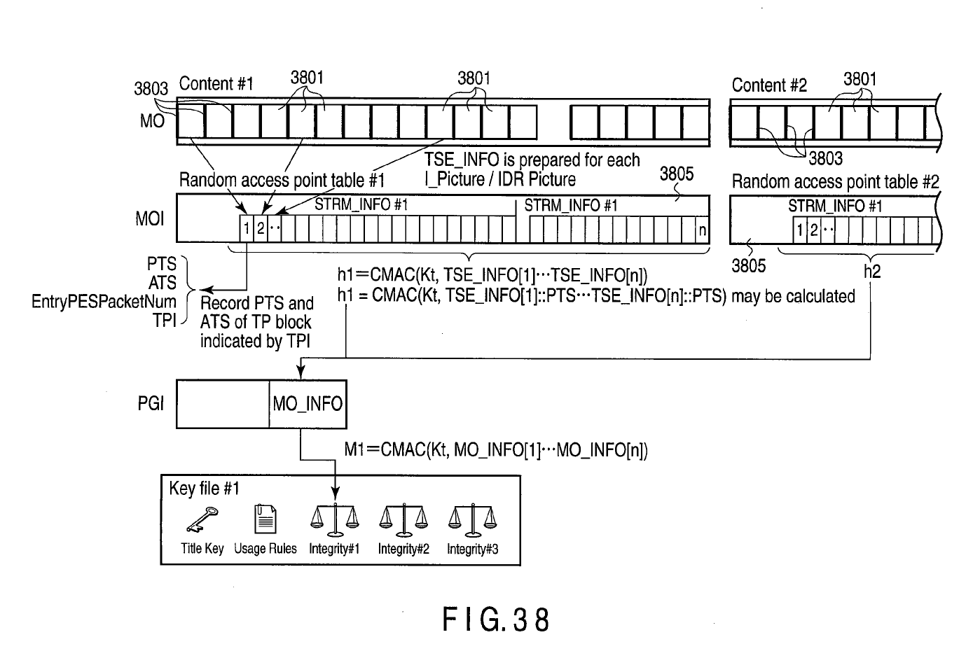

That is, the media object number referred by the present entry is recorded in MoID. Moreover, the MAC value of the whole MOI file is stored in MAC. The object ID of the program is recorded. It is to be noted that MAC corresponds to AES-CMAC, and has a message authentication code (MAC value) obtained by using, as a key, the title key of the whole MOI file of the media object corresponding to MoID. A target region does not have to be the whole MOI as long as the lump of TSE_INFO is included in the target region. A region where the digest of TSE_INFO is obtained may be the whole table including all fields constituting TSE_INFO, or a part of the constitution of TSE_INFO, for example, the only ATS or PTS or a compositive combination of them. FIG. 38 shows a case where the message authentication code value is obtained from an MAC function based on an AES cipher.

FIG. 31 is similarly a schematic diagram showing one example of the rule (application) applied to the image recording/reproduction apparatus shown in FIGS. 1, 2 and 5 and the data structure recommended by the same rule, and showing a part of a data structure of data included in the media object.

That is, one media object has a head of 16 bytes which is not encrypted, and subsequently includes ‘a transport stream block’ of 6128 bytes.

Each media object is fragmented into TTS packets each of 192 bytes. A head of 32 bytes in each TTS packet holds the ATS described above.

FIG. 32 is similarly a schematic diagram showing one example of the rule (application) applied to the image recording/reproduction apparatus shown in FIGS. 1, 2 and 5 and the data structure recommended by the same rule, showing a part of data included in the media object information shown in FIG. 31, and including at least a field name Data Type in which ‘a data type indicator’ is stored; a field name Data Size in which ‘the size of data’ is stored; a field name Version in which ‘the version of the data’ is stored; and a field name TstType in which ‘the type of a time search table’ is stored.

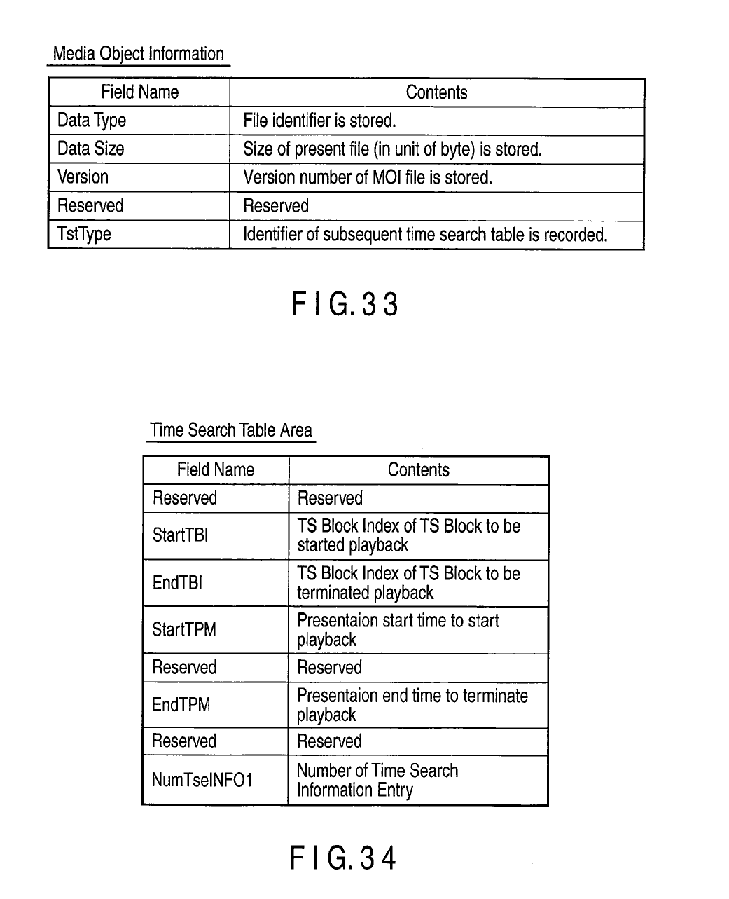

FIG. 33 is similarly a schematic diagram showing one example of the rule (application) applied to the image recording/reproduction apparatus shown in FIGS. 1, 2 and 5 and the data structure recommended by the same rule, and showing the functions of Data Type, Data Size, Version and TstType shown in FIG. 32.

That is, a file identifier is stored in the data type. Moreover, the size (in unit of byte) of the present file is stored in the data size. Furthermore, the version number of MOI file is stored in the version. It is to be noted that in TstType, the identifier of the subsequent time search table is recorded.

FIG. 34 is similarly a schematic diagram showing one example of the rule (application) applied to the image recording/reproduction apparatus shown in FIGS. 1, 2 and 5 and the data structure recommended by the same rule, showing a part of data included in a time search table area, and including at least a field name StartTBI in which ‘TS block index of TS block started to be played back’ is stored; a field name EndTBI in which ‘TS block index of TS block terminated to be played back’ is stored; a field name StartTPM in which ‘a presentation start time to start the playback’ is stored; and a field name EndTPM in which ‘a presentation end time to terminate the playback’ is stored.

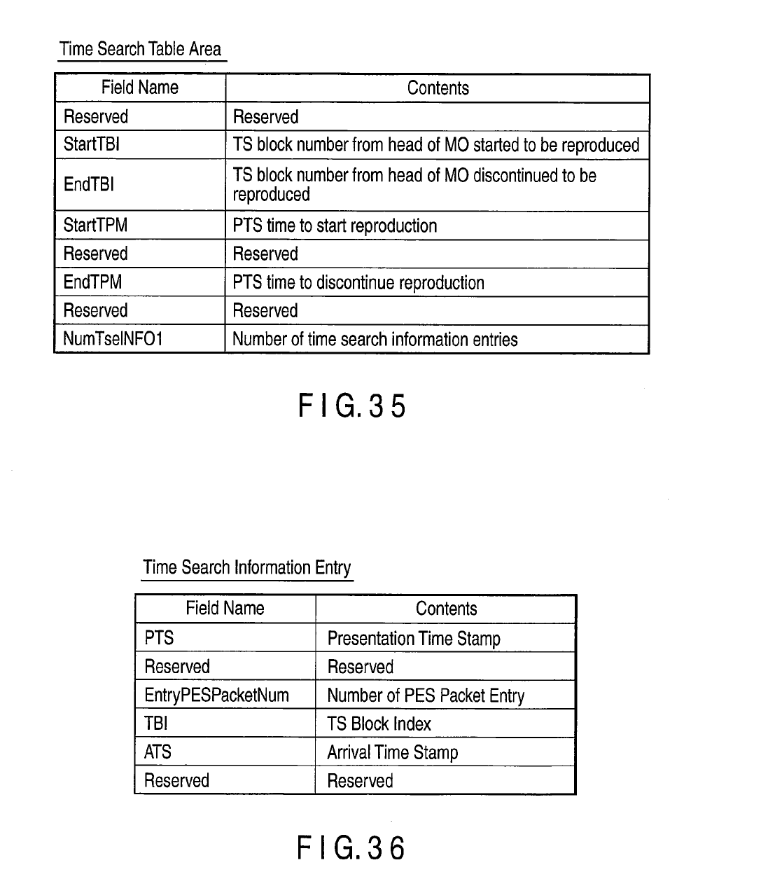

FIG. 35 is similarly a schematic diagram showing one example of the rule (application) applied to the image recording/reproduction apparatus shown in FIGS. 1, 2 and 5 and the data structure recommended by the same rule, and showing the functions of StartTBI, EndTBI, StartTPM and EndTPM shown in FIG. 34.

That is, the TS block number from the head of the MO started to be reproduced is recorded in StartTBI. Moreover, the TS block number from the head of the MO discontinued to be reproduced is recorded in EndTBI. It is to be noted that in StartTPM and EndTPM, a PTS time to start the reproduction and a PTS time to discontinue the reproduction are recorded, respectively.

FIG. 36 is similarly a schematic diagram showing one example of the rule (application) applied to the image recording/reproduction apparatus shown in FIGS. 1, 2 and 5 and the data structure recommended by the same rule, showing a part of data included in a time search information entry, and including at least a field name PTS in which ‘a presentation time stamp’ is stored; a field name EntryPESPacketNum in which ‘the number of PES packet entries’ is stored; a field name TBI in which ‘TS block index’ is stored; and a field name ATS in which ‘an arrival time stamp’ is stored.

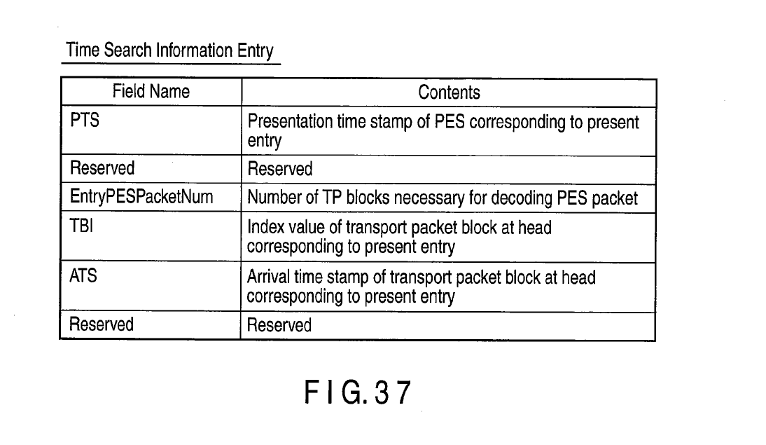

FIG. 37 is similarly a schematic diagram showing one example of the rule (application) applied to the image recording/reproduction apparatus shown in FIGS. 1, 2 and 5 and the data structure recommended by the same rule, and showing the functions of PTS, EntryPESPacketNum, TBI and ATS shown in FIG. 35.

That is, the presentation time stamp of the PES corresponding to the present entry is recorded in PTS. Moreover, the number of TP blocks necessary for decoding the PES packet is recorded in EntryPESPacketNum. Furthermore, the index value of the transport packet block at the head corresponding to the present entry is stored in TBI. It is to be noted that in ATS, the arrival time stamp of the transport packet block at the head corresponding to the present entry is stored.

FIG. 38 shows the recording of the data into the memory card (SD card) by the recording apparatus described with reference to FIG. 1 from the viewpoint of the data, which is an example different from that shown in FIG. 3.

In FIG. 38, a data structure is similar to that of the example shown in FIGS. 3 and 4, and hence the detailed description thereof is omitted. The structure is characterized in that the MAC value of the random access point table (see MO_INFO in FIGS. 29 and 30) is obtained and recorded in the key file. It is to be noted that in the example of FIG. 38, the only MO_INFO pieces having the same Tkure are connected and calculated.

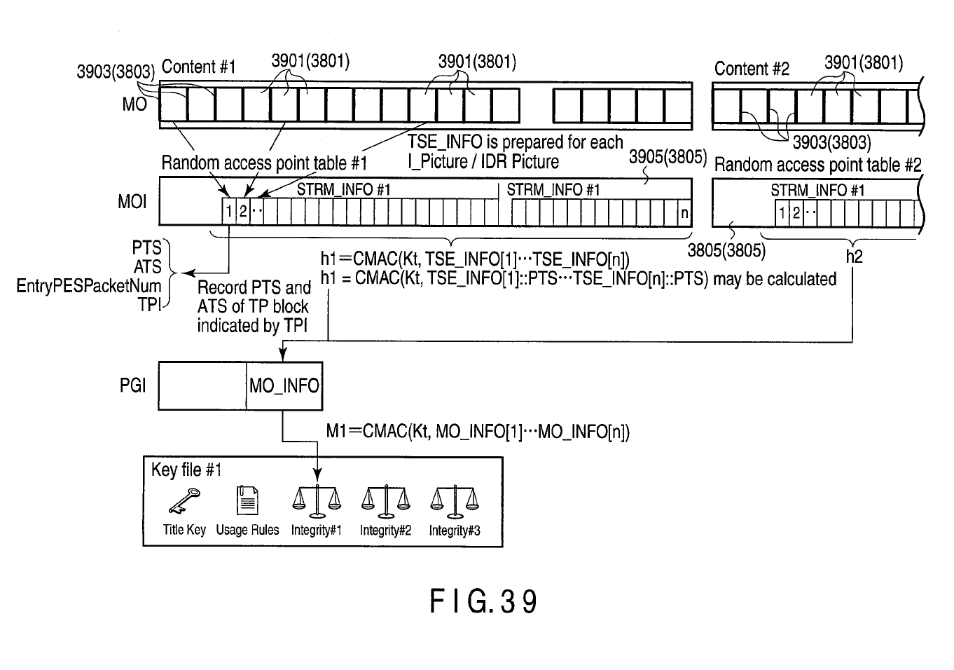

FIG. 39 shows the reproduction of the data from the memory card (SD card) by the reproduction apparatus described with reference to FIG. 2 from the viewpoint of the data, which is an example different from that shown in FIG. 4. It is to be noted that a data structure is the same as that of FIG. 4, and hence the description thereof is omitted.

In FIG. 39, in a case where to reproduce the data, the MAC value of a random access point table 3903 is compared with an MAC value recorded in a key file prior to the reproduction and eventually the values are collated (both values match each other), the reproduction is started (reproduction is allowed).

It is to be noted that the confirmation during the reproduction shown in FIG. 39 is performed not only during the reproduction but also during editing, for example, before the execution of each of operations such as content dividing, combining, partial deletion, copying (duplication) and moving. Moreover, during the editing, the content may or may not be re-encrypted by another title key. It is to be noted that MAC (title key and ATS) or MAC (title key and PTS) is recorded in the random access point table so that the title key can closely be concerned with the ATS or the PTS.

This method solves problems of the present editing function which are demanded to be solved:
1) the title key which encrypts the content as a moving target needs to be securely deleted, and hence all the contents that share this title key cannot be used; and
2) all the contents using the title key which encrypts the content as the moving target need to be moved all together.

That is, when the content is moved within the same recording medium (media) or to a different recording medium, a content of a portion other than a desired portion does not become unusable but can be left so that the content can continuously be utilized.

As described above, the embodiment of this invention can be used to solve the previous problem that as to the contents recorded in the recording medium (media), the contents which share the same title key are divided, moved and eventually copied. Specifically, the tampering of the contents can be detected to prohibit the copying, and an only necessary part of the contents can be moved.

Moreover, the hash value of the management data in which the reproduction start point of the content and the like are stored can be calculated to noticeably save processing cost for calculating the hash value, and the time stamps concerned with the decryption of the content are compared during the reproduction to substantially confirm the tampering of the content itself, whereby preprocessing for utilizing the content can noticeably be alleviated, and a time required for starting the utilization can be shortened.

It is to be noted that as compared with the existing AACS copy protection system, the move processing of a portion desired by the user can be realized while enjoying the merit that the same title key is shared.

That is, it is possible to realize copy protection executed when copying or moving (recording or editing) the content and reproducing the copied or moved content, content images recording and reproduction apparatuses to which the copy protection is applied, i.e., the recording apparatus, the reproduction apparatus and the editing apparatus, and methods of the recording, reproduction and editing. It is possible to realize the content recording apparatus, the reproduction apparatus and the editing apparatus, and the methods of the recording, reproduction and editing so that the content of the portion other than the desired portion does not become unusable but can be left to be continuously usable when recording, reproduction or editing the images and music, i.e., the contents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content recording apparatus comprising:
a key preparing section configured to prepare a key to encrypt an acquired stream;
a file preparing section configured to add identification information to the acquired stream to prepare a file;
a hash calculating section configured to calculate a hash value concerning the identification information added to the stream by the file preparing section;
a key file preparing section configured to integrate the hash value calculated by the hash calculating section and the key prepared by the key preparing section to prepare a key file; and
a writing section configured to write the key file prepared by the key file preparing section in the protected area of a recording medium.

2. The apparatus of claim 1, wherein a condition file in which use conditions are described is attached to the key prepared by the key preparing section.

3. A content reproduction apparatus comprising:
a management data analysis section configured to acquire management data of a content held by a recording medium;
a reading section configured to refer to the analysis result of the management data analysis section to read a key file;
a key file analysis section configured to analyze the key file read by the reading section to acquire a key and a hash value;
a hash calculation/comparison section configured to compare the hash value acquired by the key file analysis section with a hash value included in the management data acquired by the management data analysis section; and
a control section configured to allow the reproduction of a filed content in accordance with the comparison result of the hash calculation/comparison section.

4. The apparatus of claim 3, wherein the key file analysis section refers to a condition file in which use conditions attached to the key are described, to confirm the use conditions.

5. The apparatus of claim 3, wherein the management data analysis section successively refers to identification information attached to the filed content.

6. The apparatus of claim 3, further comprising:
an identification information comparison section configured to refer to identification information included in the management data acquired by the management data analysis section,
wherein the identification information is successively compared with identification information attached to the filed content.

7. A content editing apparatus comprising:
a management data analysis section configured to acquire management data of a content held by a recording medium;
a reading section configured to refer to the analysis result of the management data analysis section to read a key file;
a key file analysis section configured to analyze the key file read by the reading section to acquire a key and a hash value;
a hash calculation/comparison section configured to compare the hash value acquired by the key file analysis section with a hash value included in the management data acquired by the management data analysis section;
a reproduction control section configured to allow the reproduction of a filed content in accordance with the comparison result of the hash calculation/comparison section;
a key preparing section configured to prepare a key to encrypt a stream to be reproduced when the reproduction is allowed by the reproduction control section;
a file preparing section configured to add identification information to the stream to prepare a file;
a hash calculating section configured to calculate a hash value concerning the identification information added to the stream by the file preparing section;
a key file preparing section configured to integrate the hash value calculated by the hash calculating section and the key prepared by the key preparing section to prepare a key file; and
a writing section configured to write the key file prepared by the key file preparing section in the protected area of the recording medium.

8. The apparatus of claim 7, wherein the key file analysis section refers to a condition file in which use conditions attached to the key are described, to confirm the use conditions.

9. The apparatus of claim 7, further comprising:
an identification information comparison section configured to refer to identification information included in the management data acquired by the management data analysis section,
wherein the identification information is successively compared with identification information attached to the filed content.

10. A content reproduction method comprising:
acquiring management data of a content held by a recording medium;
referring to the analysis result of the acquired management data to read a key file;
analyzing the read key file to acquire a key and a hash value;
comparing the acquired hash value with a hash value included in the management data; and
allowing the reproduction of a filed content in accordance with the comparison result.

11. A content recording method comprising:
preparing a key to encrypt an acquired stream;
adding identification information to the acquired stream to prepare a file;
calculating a hash value concerning the identification information added to the stream;
integrating the hash value and the key to prepare a key file; and
writing the key file in the protected area of a recording medium.

12. A content editing method comprising:
acquiring management data of a content held by a recording medium;
referring to the analysis result of the acquired management data to read a key file;
analyzing the read key file to acquire a key and a hash value;
comparing the acquired hash value with a hash value included in the management data;
allowing the reproduction of a filed content in accordance with the comparison result;
preparing a key to encrypt an allowed and reproduced stream;
adding identification information to the acquired stream to prepare a file;
calculating a hash value concerning the identification information added to the stream;
integrating the hash value and the key to prepare a key file; and
writing the key file in the protected area of the recording medium.
